(19) United States
(12) Patent Application Publication
(10) Pub. No.: US 2025/0102290 A1
(43) Pub. Date: Mar. 27, 2025

(54) Optical Coherence Tomography System for Subsurface Inspection

(71) Applicants: Hamamatsu Photonics K.K., Shizuoka (JP); Energetiq Technology, Inc., Wilmington, MA (US)

(72) Inventors: Qingsong Wang, Lexington, MA (US); Shaival Vipul Buch, Watertown, MA (US); Huiling Zhu, Lexington, MA (US)

(73) Assignees: Hamamatsu Photonics K.K., Shizuoka (JP); Energetiq Technology, Inc., Wilmington, MA (US)

(21) Appl. No.: 18/783,208

(22) Filed: Jul. 24, 2024

Related U.S. Application Data
(62) Division of application No. 18/473,224, filed on Sep. 23, 2023, now Pat. No. 12,085,387.

(51) Int. Cl. G01B 9/02091; G01B 9/02; G01B 9/02055; G01N 21/47

(52) U.S. Cl. CPC G01B 9/02091; G01B 9/02044; G01B 9/0207; G01N 21/4795

(57) ABSTRACT

An OCT system includes a broadband light source and illumination optics that projects the generated broadband light to a sample where the light is scattered from within the sample in a direction that is normal to a surface of the sample to form a sample beam and is reflected from a top surface of the sample in a direction that is normal to the surface of the sample to form a reference beam where the sample beam and reference beam co-propagate. Collection optics collect light in the sample and reference beams and project the light to an interferometric combiner. The interferometric combiner is configured to interferometrically the collected light from the sample beam and collected light from the reference beam and to project the interferometrically combined light to a spectrometer that generates spectral interferometric information to determine information about the sample.

The section headings used herein are for organizational purposes only and should not be construed as limiting the subject matter described in the present application in any way.

### INTRODUCTION

Optical coherence tomography (OCT) is commonly used for minimally invasive optical imaging in medical application. Optical coherence tomography can provide high-resolution, cross-sectional images of tissues which can seamlessly integrated into other diagnostic procedures. In particular, OCT has revolutionized the practice of ophthalmology. Also, OCT can provide real-time images of tissues in situ where conventional excisional biopsy is hazardous or impossible. Optical coherence tomography is useful for many other applications such as imaging, ranging, sensing, and communication.

### SUMMARY

One aspect of the present teaching is a bright field optical coherence tomography system that includes a broadband light source that generates broadband light. Illumination optics projects the generated broadband light to a sample positioned so that at least some of the projected generated broadband light is scattered from within the sample in a direction that is normal to a surface of the sample to form a sample beam and at least some of the projected generated broadband light is reflected from a top surface of the sample in a direction that is normal to the surface of the sample to form a reference beam. Collection optics collects light in the sample beam and in the reference beam, and projects the collected light to an interferometric combiner. The illumination optics and the collection optics together form reflective imaging optics where light in the sample beam co-propagates with light in the reference beam without transmission through dispersive optical elements, thereby reducing the OCT system dispersion and chromatic aberration. An interferometric combiner interferometrically combine the collected light from the sample beam and collected light from the reference beam and projects the interferometrically combined light to a spectrometer that generates spectral interferometric information from the combined sample and reference beams. A processor processes the spectral interferometric information to determine information about the sample.

Another aspect of the present teaching is a dark field optical coherence tomography system that includes a broadband light source that generates broadband light. A beam splitter splits the generated broadband light into a reference beam and an illumination beam. A reference mirror reflects the reference beam. Illumination optics includes a transparent region that passes the illumination beam and a reflective surface with an optical power. Collection optics has a transparent region and a reflective surface with an optical power that reflects the illumination beam from the reflective surface of the collection optics to the reflective surface of the illumination optics such that the illumination beam is redirected to a surface of the sample at an angle that results in scattering from within the sample that forms a sample beam propagating normal to the surface of the sample and through the transparent region of collection optics and through the transparent region of the illumination optics. An interferometric combiner interferometrically combines the sample beam and the reference beam to provides the combined beam to a spectrometer that generates spectral interferometric information. A processor processes the spectral interferometric information to determine information about the sample.

### BRIEF DESCRIPTION OF THE DRAWINGS

The present teaching, in accordance with preferred and exemplary embodiments, together with further advantages thereof, is more particularly described in the following detailed description, taken in conjunction with the accompanying drawings. The skilled person in the art will understand that the drawings described below are for illustration purposes only. The drawings are not necessarily to scale; emphasis is instead generally being placed upon illustrating principles of the teaching. The drawings are not intended to limit the scope of the Applicant's teaching in any way.

FIG. 1 illustrates a spectral domain optical coherence tomography system with bright field optical beam collection according to the present teaching.

FIG. 2 illustrates a spectral domain optical coherence tomography system according to the present teaching that uses ellipsoidal illumination optics with bright field optical beam collection.

FIG. 3 shows an image of interference fringes of an interferometrically combined reference beam and scattered beam generated by the optical coherence tomography system described in connection with FIG. 2.

FIG. 4 illustrates a diagram showing the sample beam generating the reference beam and scattered beam in the sample using the spectral domain optical coherence tomography system described in connection with FIG. 2.

FIG. 5 illustrates a spectral domain optical coherence tomography system with dark field optical beam collection according to the present teaching.

### DESCRIPTION OF VARIOUS EMBODIMENTS

The present teaching will now be described in more detail with reference to exemplary embodiments thereof as shown in the accompanying drawings. While the present teaching is described in conjunction with various embodiments and examples, it is not intended that the present teaching be limited to such embodiments. On the contrary, the present teaching encompasses various alternatives, modifications, and equivalents, as will be appreciated by those of skill in the art. Those of ordinary skill in the art having access to the teaching herein will recognize additional implementations, modifications, and embodiments, as well as other fields of use, which are within the scope of the present disclosure as described herein.

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the method of the present teaching can be performed in any order and/or simultaneously as long as the teaching remains operable. Furthermore, it should be understood that the apparatus and method of the present teaching can include any number or all of the described embodiments as long as the teaching remains operable.

One aspect of the present teaching is spectral domain optical coherence tomography system and methods according to the present teaching that can provide improved imaging for numerous medical application. In addition, the spectral domain optical coherence tomography system according to the present teaching have numerous other industrial application, such as subsurface inspection. For example, the systems and methods according to the present teaching can be used to determine subsurface material defects in precision optics that are source of back-scattering light signal which degrades the performance of the optical elements. It is important to determine these subsurface material defects during manufacturing of many products and system.

It should be understood that the spectral domain optical coherence tomography systems of the present teaching can be configured in a bright field or in a dark field configuration. Also, it should be understood that the systems according to the present teaching can be configured in free space optical configuration or in a fiber or wave guided configuration where at least some of the optical paths are guided.

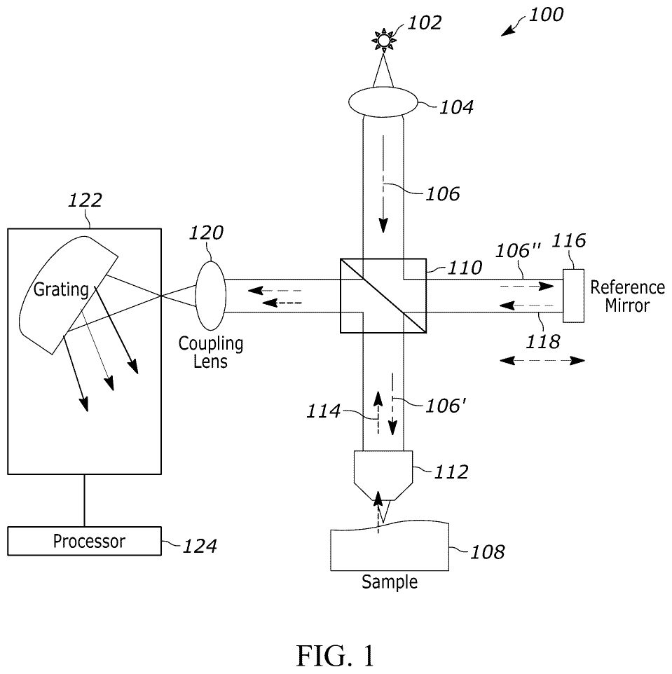

FIG. 1 illustrates a spectral domain optical coherence tomography (OCT) system 100 with bright field optical beam collection according to the present teaching. The OCT system 100 includes a broadband light source 102 that generates broadband light for applications, such as inspection. Numerous broadband light sources can be used in the apparatus of the present teaching. For example, the broadband light source 102 can be a laser driven light source, a superluminescent diode, a supercontinuum broadband light source, and/or a short-pulse laser. In particular, a suitable short pulse light source is a titanium-sapphire laser that emits red and near-infrared light in the range from 650 to 1100 nanometers. In other configurations, the broadband light source 102 is a light source configured to generate at least some light in the ultraviolet region having a wavelength that is less than 400 nm or even less than 300 nm. In other configurations, the broadband light source 102 generates at least some light in a visible region of the spectrum. In other configurations, the broadband light source 102 generates at least some light in a near-infrared region of the spectrum. In yet other configurations, the broadband light source 102 generates at least some light in each of the ultraviolet, visible, and near-infrared regions of the spectrum.

Illumination optics 104, 112 are optically coupled to the broadband light source 102. For example, the illumination optics 104, 112 can be as simple as a collimating lens that projects and collimates, or nominally collimates, the generated broadband light into a collimated beam 106 that is directed to a sample 108, which can be living tissue to be analyzed or an object to be inspected. In one particular application, the surface of the sample 108 being inspected is polished and the OCT system is used for subsurface inspect. In one particular embodiment, the illumination optics 104, 112 is an ellipsoidal mirror that includes two focal points or a pair of off-axis parabolic mirrors as described in more detailed herein.

A beam splitter/combiner 110 is positioned in the path of the collimated beam 106 so as to provide interferometric combining. In various embodiments, the beam splitter/combiner 110 can be an optical fiber combiner, a Y-fiber combiner, a 2λ2 fiber combiner, a free space combiner, or an optical circulator. A first portion 106′ of the collimated beam 106 propagates towards the sample 108. In some configurations, focusing optics 112, such as the objective lens shown in FIG. 1, is used to focus the first portion 106′ of the collimated beam 106 to the sample 108. In some configurations, the illumination optics 104 and the focusing optics 112 comprise at least one common optical element.

Broadband light in the first portion 106′ of the collimated beam 106 is scattered from within the sample 108 in a direction that is normal to the top surface of the sample 108 and is also reflected from a top surface of the sample 108 in a direction that is normal to the surface of the sample 108. The combined scattered and reflected light forms a sample beam 114 that propagates back towards the beam splitter/combiner 110.

The beam splitter/combiner 110 directs a second portion 106″ of the collimated beam 106 towards a reference mirror 116 that reflects the second portion 106″ of the collimated beam 106 back to the beam splitter/combiner 110 to form a reference beam 118. The position of the reference mirror 116 is adjustable so that the reference mirror 116 translates back-and-forth in the direction of propagation of the reference beam 118. The reference mirror 116 is positioned to create a desired length of a reference path, which is the path the reference beam 118 follows from the beam splitter/combiner 110 to the reference mirror 116 and back to the beam splitter/combiner 110. In some embodiments, the reference mirror 116 is configured such that the reflection from the reference mirror 116 results in the reference beam 118 having a low numerical aperture.

The reference beam 118 and the sample beam 114 are interferometrically combined at the beam splitter/combiner 110. In some optical configurations, the illumination optics 104 and the focusing optics 112 are configured so that a difference between a position of the sample beam 114 and a position of the reference beam 118 at a surface of the sample 108 is less than 10 micrometers.

The beam splitter/combiner 110 then directs the interferometrically combined reference beam 118 and sample beam 114 to coupling or collection optics 120, which in the configuration shown in FIG. 1 is a lens such as an objective lens that focuses the interferometrically combined reference beam 118 and sample beam 114 to the input of a spectrometer 122. In particular embodiments, the collection optics 120 is an ellipsoidal mirror with two focal points or a pair of off-axis parabolic mirrors as described in further detail herein. In various embodiments, the optical path from the collection optics 120 to the spectrometer 122 can be a path that propagates in a single mode fiber or a path that propagates in free space, or both.

The interferometrically combined reference beam 118 and sample beam 114 generate interference fringes across the phase front of the resulting combined beam. These fringes can be imaged, or otherwise projected and/or shaped by various output optics. The spectrometer 122 processes the interferometrically combined reference beam 118 and sample beam 114 to generate spectral interferometric information related to features on the surface of the sample 108 and features within the sample 108.

A processor 124 is electrically coupled to the spectrometer 120. The processor 124 processes the spectral interferometric information related to features on the surface and features below the surface of the sample 108 that are generated by the spectrometer 122 to obtain image or image information about these features. For example, the processor 124 can processes the spectral interferometric information generated by the spectrometer to determine precise defect locations in the sample 108 in three dimensions. The processor 124 can also determine defect densities in the sample 108.

One aspect of the present teaching is spectral domain optical coherence tomography system that collects light in the bright field but does not propagate light through dispersive media other than air. This can be achieved in part by using ellipsoidal illumination optics such as optics including an ellipsoidal mirror that includes two focal points.

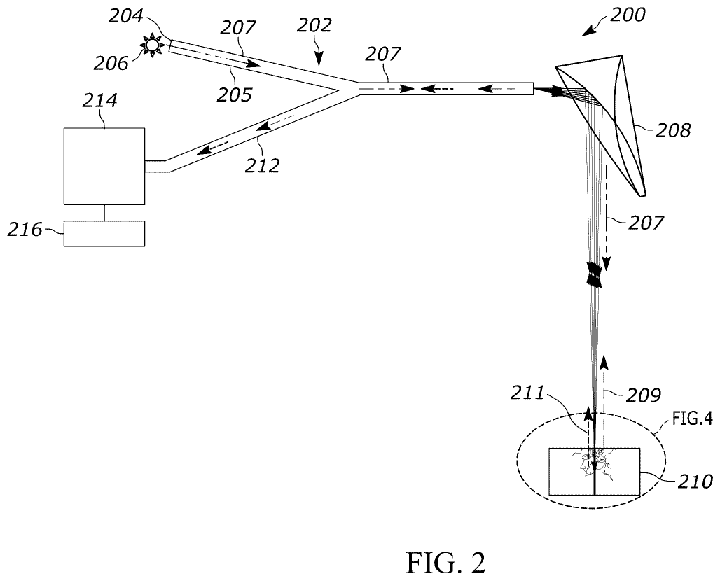

FIG. 2 illustrates a spectral domain optical coherence tomography system 200 according to the present teaching that uses ellipsoidal illumination optics with bright field optical beam collection. Referring to both FIG. 1 and FIG. 2, in this configuration, the collection optics 104 and reference mirror 116 shown in FIG. 1 are combined in the ellipsoidal mirror 208.

In the embodiment shown, a Y-fiber coupler 202 includes an input 204 at a first arm 205 that is optically coupled to a light source 206 that generates an illumination beam 207. The ellipsoidal illumination optics comprises an ellipsoidal mirror 208 that is configured in a shape that provides two focal points. The output of the Y-fiber coupler 202 directs the illumination beam 207 to a first focal point on the ellipsoidal mirror 208. The ellipsoidal mirror 208 directs the illumination beam 207 to a sample 210 that is under measurement and/or inspection. The sample 210 reflects a portion of the illumination beam 207 from the top surface of the sample 210 to form a reference beam 209. The sample also scatters another portion of the sample beam 207 from within the sample 210 to form a scattered beam 211. Light in the illumination beam 207 co-propagates (in an opposite direction) with light in the reference beam 209 and with light in the scattered beam 211 in a single optical path that may have an offset.

The reference beam 209 and the scattered beam 211 co-propagate in the same direction back to a second focal point of the ellipsoidal mirror 208. The ellipsoidal mirror 208 interferometrically combines the reference beam 209 and the scattered beam 211 and then reflects the combined beam back to the output of the Y-fiber coupler 202 and then to an input of the second arm 212 of the Y-fiber coupler 202.

The output of the second arm of the Y-fiber coupler 202 is coupled to a spectrometer 214 that generates interference fringes across the phase front of the resulting combined beam. These fringes can be imaged, or otherwise projected and/or shaped by various output optics. The spectrometer 214 processes the interferometrically combined reference beam 209 and scattered beam 211 to generate spectral interferometric information related to features on the surface and features within the sample 210.

A processor 216 is electrically coupled to the spectrometer 214. The processor 216 processes the spectral interferometric information related to features on the surface and features below the surface of the sample 210 that are generated by the spectrometer 214 to obtain image or image information about these features. For example, the processor 216 can processes the spectral interferometric information generated by the spectrometer 214 to determine precise defect locations in the sample 210 in three dimensions. The processor 216 can also determine defect densities in the sample 210.

Features of this bright field optical configuration of the optical coherence tomography system of the present teaching include the ability to generate a high quality broadband light illuminating sample beam. Also, this bright field optical configuration provides a reference beam and scattered beam with a relatively low numerical aperture. Also, the bright field optical configuration has relatively high optical efficiency and relatively low optical dispersion. In addition, since the broadband light sample beam, reference beam, and scattered beam have overlapping paths, this optical configuration has relatively low noise and relatively low generation of ghost signal from the various interfaces. Furthermore, this bright field optical configuration is resistant to environmental vibration and turbulence.

In one specific application of the optical coherence tomography system of the present teaching, the optical coherence tomography system detects and/or evaluates subsurface defects caused by polish damage in precision optics. Having such information on subsurface defects can drastically reduce polishing costs especially for relatively large precision optics as subsurface defects are known to cause back-scattering of light signals that can substantially impact the optical performance and, can even make the precision optics unusable for its intended purpose. Such information greatly reduces testing costs and time and adds very substantially to the manufacturability of these precision optics.

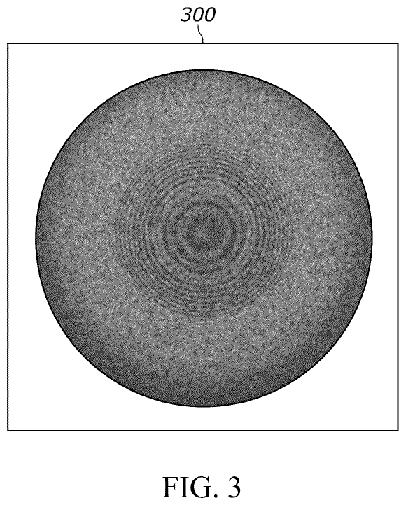

FIG. 3 shows an image 300 of interference fringes of an interferometrically combined reference beam and scattered beam generated by the optical coherence tomography system described in connection with FIG. 2. The image shows scattering across the phase front which indicates details of defects below the surface of the sample 210.

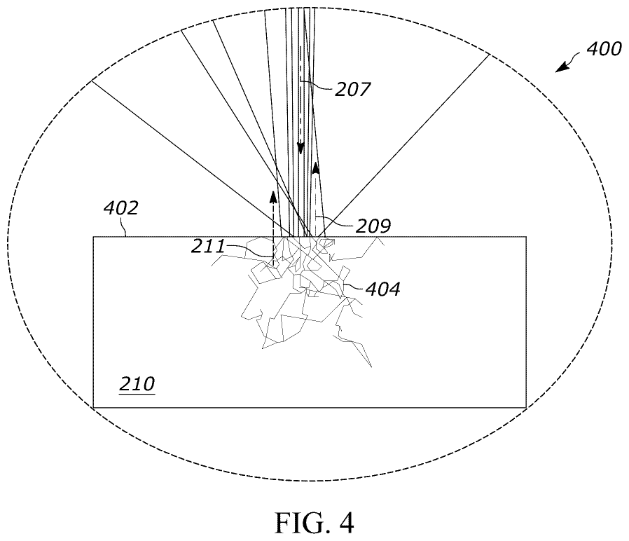

FIG. 4 illustrates a diagram 400 showing the sample beam 207 generating the reference beam 209 and scattered beam 211 in the sample 210 using the spectral domain optical coherence tomography system 200 described in connection with FIG. 2. The sample beam 207 propagates to the surface of the sample 210, which is shown as an air/substrate interface 402. The reference beam 209 reflects from the air/substrate interface 402 of the substrate 210 at the interface 402. Defects 404 within the sample 210 scatter the sample beam 207, thereby generating a beam that propagates out of the air/substrate interface 402 of the sample 210 thereby forming the scattered beam 211.

Another feature of the optical coherence tomography system of the present teaching is the realization that the optical coherence tomography systems configured for subsurface defect inspection using broadband light is also compatible with a dark field optical beam collection configuration.

One challenge with embodiments using a dark field optical configuration is obtaining an optically efficient and high quality illumination sample beam at the sample under inspection. Dark field optical systems typically have illumination beams with high numerical apertures that have relatively low optical power efficiency. In addition, dark field optical systems can have higher noise and optical impairments because ghost signals can be generated. Furthermore, the illumination optical beam input angle when it reaches the sample surface can be tilted with respect to a normal to the sample's surface, which can further reduce the optical efficiency of the dark field optics.

In addition, dark field optical configuration can have more physical optical components than similar bright field configurations. These components include beam splitters, optical beam directing components, and optical beam shaping components. These additional optical components have optical interfaces for the illumination sample beam, reference beam and scattered beam to propagate through and/or reflect from. Consequently, there can be significant losses, back reflections, and/or phase front distortions associated with each interface that can impact the optical performance of the system.

Also, in some dark field optical configurations, the magnitude of the reflections from the surface of the sample back to the spectrometer, or other measurement equipment, can be lower than in similar bright field optical configurations. The lower reflections occur despite having an illumination beam that can have a relatively high numerical aperture. This is, at least in part, because the sample and reference beams often have a low numerical aperture compared with bright field configuration.

At the same time, however, there are certain advantages of dark field optical configurations compared with the bright field optical configurations of the present teaching for applications such as subsurface defect inspection. Dark field imaging according to the present teaching is achieved with two additional reflections compared with bright field configurations according to the present teaching. As a result, as described further herein, no reflections from the surface of the sample propagate to into collection optics. In particular, specular reflections are avoided with this configuration. Chromatic aberrations are also reduced. In addition, dark field optical configurations are advantageous in that they can have much higher contrast.

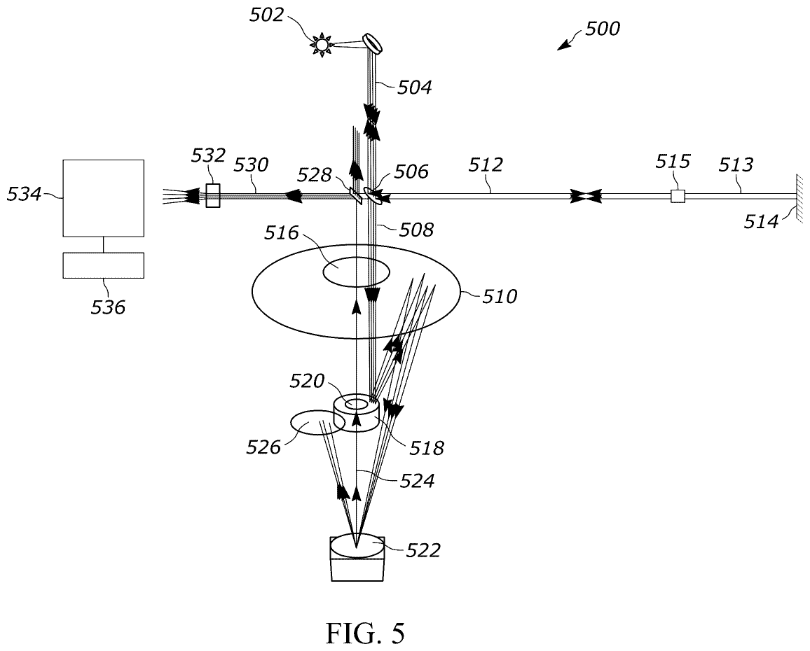

FIG. 5 illustrates a spectral domain optical coherence tomography system 500 with dark field optical beam collection according to the present teaching. A broadband light source 502 generates an optical illumination beam 504. Numerous broadband light sources can be used in the apparatus of the present teaching. For example, the broadband light source 502 can be a laser driven light source, a superluminescent diode, a supercontinuum broadband light source, and/or a short-pulse laser. In particular, a suitable short pulse light source is a titanium-sapphire laser that emits red and near-infrared light in the range from 650 to 1100 nanometers. In other configurations, the broadband light source 502 is a light source configured to generate at least some light in the ultraviolet region having a wavelength that is less than 400 nm or even less than 300 nm. In other configurations, the broadband light source 502 generates at least some light in a visible region of the spectrum. In other configurations, the broadband light source 502 generates at least some light in a near-infrared region of the spectrum. In yet other configurations, the broadband light source 502 generates at least some light in each of the ultraviolet, visible, and near-infrared regions of the spectrum.

The output of the broadband light source 502 is optically coupled to a first beam splitter 506 that passes a first portion of the optical illumination beam 508 to illumination optics 510 and passes a second portion of the optical illumination beam 512 to a reference mirror 514 where it is reflected, thereby forming a reference beam 513. In one embodiment, the first beam splitter 506 is a pellicle beam splitter. Pellicle beam splitters are sometimes advantageous as they have relatively low chromatic aberrations and they substantially eliminate ghosting.

The illumination optics 510 collimates, or nominally collimates, the optical illumination beam 504. In one embodiment of the dark field configuration, the illumination optics 510 includes an off-axis parabolic mirror. In one specific embodiment, the off-axis parabolic mirror is configured with a focal length that is nominally constant over the broad bandwidth of the optical illumination beam 504. Off-axis parabolic mirrors are sometimes desirable because they work efficiently with high-numerical aperture optical beams.

In the optical configuration shown in FIG. 5, the first portion of the optical illumination beam 508 passes through an open or substantially transparent region 516 in the illumination optics 510 to a combination mirror and collection lens 518, which, in this particular embodiment, also has a transparent region 520. The combination mirror and collection lens 518 can be a single optical element or multiple optical elements that collects and projects the second portion of the optical illumination beam 508 to a reflective portion of the illumination optics 510 where the twice reflected second portion of the illumination beam 508 is then directed to the surface of the sample 522 at an input angle that is tilted with respect to a normal to the surface of the sample 522.

A sample beam 524 is generated from light scattered off the sample 522. In some embodiments, the OCT system 500 is configured such that the sample beam 524 has a low numerical aperture. The sample beam 524 is produced by the interaction of the twice reflected first portion of the optical illumination beam 508 and the sample 522 which causes scattering of some light that is generated below the surface of the sample 522 along a scattering beam path. Some of the light is specularly reflected from the sample 522 with an output angle that is equal and opposite to the input angle to the sample 522. This light is scattered in a direction of a beam dump 526, which can be, for example, a beam block or beam trap that substantially absorbs the light.

In the configuration shown, the sample beam 524 is directed to the substantially transparent region 520 in the combination mirror and collection lens 518 and then to a second beam splitter/combiner 528. The second beam splitter/combiner 528 can also be a Pellicle beam splitter which will further reduce ghost imaging. The second portion of the optical illumination beam 512 that is reflected from the reference mirror 514 to form the reference beam 513.

The reference mirror 514 is positioned to create a desired length of a reference path, which is the path the reference beam follows from the first beam splitter 506 to the reference mirror 514 and back to the first beam splitter 506. In some embodiments, a neutral density filter 515, which can be an adjustable neutral density filter, is positioned in the reference path. The reference mirror 514 is typically configured such that the reflection from the reference mirror 514 results in the reference beam 513 having a low numerical aperture.

The reference beam 513 propagates through the first beam splitter 506 to the second beam splitter 528 where it is combined with sample beam 524 to form an interferometrially combined beam 530. The interferometrially combined beam 530 has interference fringes across its phase front.

Output optics 532 projects and/or shapes the interferometrially combined beam 530 to an input of an optical spectrometer 534. As described in connection with the OCT system of FIG. 1, the spectrometer generates spectral interferometric information from the fringes. A processor 536 that is electrically connected to the spectrometer 534 processes the spectral interferometric information to determine information about the sample 534.

One feature of the dark field optical beam collection configuration for optical coherence tomography systems according to the present teaching is that it is possible to perform level matching and/or balancing of signals using an adjustable neutral density filter, such as the filter 515 positioned within the reference arm. This adjustable neutral density filter can be configured to improve and even provide maximal interference resolution.

Another feature of the dark field optical beam collection configuration for optical coherence tomography systems according to the present teaching is that at least one of the first and second beam splitters 506, 528 can be pellicle beam splitters that direct and/or combine the illumination beam 508, reference beam 513 and/or sample beam 524. Pellicle beam splitters can have little to no chromatic aberration when processing focused beams. Consequently, the use of pellicle beam splitters can reduce or eliminate ghost imaging from beam splitter surfaces. Also, pellicle beam splitters can lead to minimal change in optical path length from input to output between the illumination beam path, sample beam path, and reference beam path.

### EQUIVALENTS

While the Applicant's teaching is described in conjunction with various embodiments, it is not intended that the Applicant's teaching be limited to such embodiments. On the contrary, the Applicant's teaching encompasses various alternatives, modifications, and equivalents, as will be appreciated by those of skill in the art, which may be made therein without departing from the spirit and scope of the teaching.

1-29. (canceled)

30. An optical coherence tomography system comprising:
a) a broadband light source that generates broadband light at an output;
b) a beam splitter that splits the generated broadband light into a reference beam and an illumination beam;
c) a reference mirror that is positioned in a path of the reference beam, the reference mirror reflecting the reference beam;
d) illumination optics positioned in a path of the illumination beam and having a transparent region that passes the illumination beam and having a reflective surface with an optical power;
e) collection optics positioned in a path of the illumination beam and having a transparent region and having a reflective surface with an optical power, the collection optics being configured so that the illumination beam is reflected from the reflective surface of the collection optics to the reflective surface of the illumination optics such that the illumination beam is redirected to a surface of a sample at an angle that results in scattering from within the sample that forms a sample beam propagating normal to a surface of the sample and through the transparent region of collection optics and through the transparent region of the illumination optics;
f) an interferometric combiner positioned in the path of the sample beam and in the path of the reference beam, the interferometric combiner being configured to interferometrically combine light from the sample beam and the reference beam;
g) a spectrometer having an input coupled to an output of the interferometric combiner, the spectrometer configured to receive the interferometrically combined light from the sample beam and the reference beam and to generate spectral interferometric information; and
h) a processor having an input coupled to an output of the spectrometer, the processor processing the spectral interferometric information to determine information about the sample.

31. The optical coherence tomography system of claim 30 wherein the reference mirror reflects the reference beam though the beam splitter to the interferometric combiner.

32. The optical coherence tomography system of claim 30 wherein the broadband light source is a laser driven light source.

33. The optical coherence tomography system of claim 30 wherein the broadband light source is a superluminescent diode.

34. The optical coherence tomography system of claim 30 wherein the broadband light source is a supercontinuum broadband light source.

35. The optical coherence tomography system of claim 30 wherein the broadband light source comprises a short-pulse laser.

36. The optical coherence tomography system of claim 30 wherein the broadband light source generates at least some light having a wavelength that is less than 400 nm.

37. The optical coherence tomography system of claim 30 wherein the broadband light source generates at least some light having a wavelength that is less than 300 nm.

38. The optical coherence tomography system of claim 30 wherein the broadband light source generates at least some light in a visible region of the spectrum.

39. The optical coherence tomography system of claim 30 wherein the broadband light source generates at least some light in a near-infrared region of the spectrum.

40. The optical coherence tomography system of claim 30 wherein the broadband light source generates at least some light having wavelengths in an ultraviolet, a visible and a near-infrared region of the spectrum.

41. The optical coherence tomography system of claim 30 wherein the interferometric combiner comprises a free space combiner.

42. The optical coherence tomography system of claim 30 wherein the illumination optics is configured to project the generated broadband light to a sample with a polished surface.

43. The optical coherence tomography system of claim 30 wherein the processor is configured to process the spectral interferometric information to determine defect locations in the sample.

44. The optical coherence tomography system of claim 30 wherein the processor is configured to process the spectral interferometric information to determine a defect density in the sample.

45. The optical coherence tomography system of claim 30 wherein the interferometrically combined light from the sample beam and the reference beam is projected through an optical fiber.
